(19) United States
(12) Patent Application Publication
(10) Pub. No.: US 2016/0265996 A1
(43) Pub. Date: Sep. 15, 2016

(54) SENSOR DEVICE

(71) Applicant: KABUSHIKI KAISHA TOSHIBA, Tokyo (JP)

(72) Inventor: Yumi HAYASHI, Ayase Kanagawa (JP)

(73) Assignee: KABUSHIKI KAISHA TOSHIBA, Tokyo (JP)

(21) Appl. No.: 14/841,411

(22) Filed: Aug. 31, 2015

(30) Foreign Application Priority Data
Mar. 12, 2015 (JP) 2015-049494

(51) Int. Cl. G01L 9/00

(52) U.S. Cl. CPC G01L 9/0072

(57) ABSTRACT

According to one embodiment, a sensor device includes a variable capacitor including a first electrode fixed to an underlying layer, and a movable second electrode provided above the first electrode, and a stacked structure including a plurality of layers and having a connection connected to the second electrode, the stacked structure covering the variable capacitor and forming a cavity therein, wherein a predetermined layer included in the plurality of layers is not provided in a first area that includes at least part of the connection.

### CROSS-REFERENCE TO RELATED APPLICATIONS

This application is based upon and claims the benefit of priority from Japanese Patent Application No. 2015-049494, filed Mar. 12, 2015, the entire contents of which are incorporated herein by reference.

### FIELD

Embodiments described herein relate generally to a sensor device.

### BACKGROUND

A variable capacitor using sensor technology has been proposed. The variable capacitor is generally covered with a stacked structure comprising a plurality of layers. The stacked structure is connected to the upper electrode of a variable capacitor at a connection, and the upper electrode of the variable capacitor is displaced in accordance with displacement of the stacked structure.

However, if the connection of the stacked structure is thermally expanded, the distance between the electrodes of the variable capacitor will spread and the change of capacitance will become small.

Therefore, there is a demand for a sensor device wherein thermal expansion of the connection of the stacked structure is suppressed.

### BRIEF DESCRIPTION OF THE DRAWINGS

FIG. 1 is a schematic cross-sectional view showing the structure of a sensor device according to a first embodiment;

FIG. 2 is a plan view showing the structure of the sensor device according to the first embodiment;

FIG. 3 is a schematic cross-sectional view showing part of a process of manufacturing the sensor device of the first embodiment;

FIG. 4 is another schematic cross-sectional view showing part of the process of manufacturing the sensor device of the first embodiment;

FIG. 5 is yet another schematic cross-sectional view showing part of the process of manufacturing the sensor device of the first embodiment; and

FIG. 6 is a schematic cross-sectional view showing the structure of a sensor device according to a second embodiment.

### DETAILED DESCRIPTION

In general, according to one embodiment, a sensor device includes: a variable capacitor including a first electrode fixed to a underlying layer, and a movable second electrode provided above the first electrode; and a stacked structure including a cavity formed therein, a plurality of layers, and a connection connected to the second electrode, the stacked structure covering the variable capacitor, wherein a predetermined layer included in the plurality of layers is not provided in a first area that includes at least part of the connection.

Embodiments will be described with reference to the accompanying drawings.

### First Embodiment

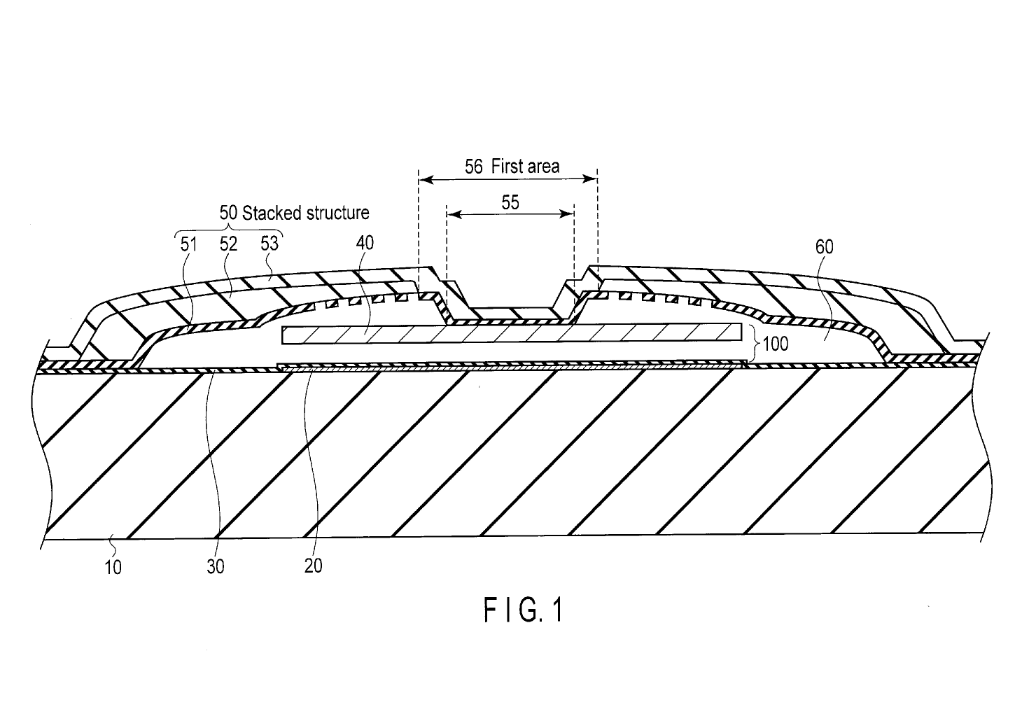

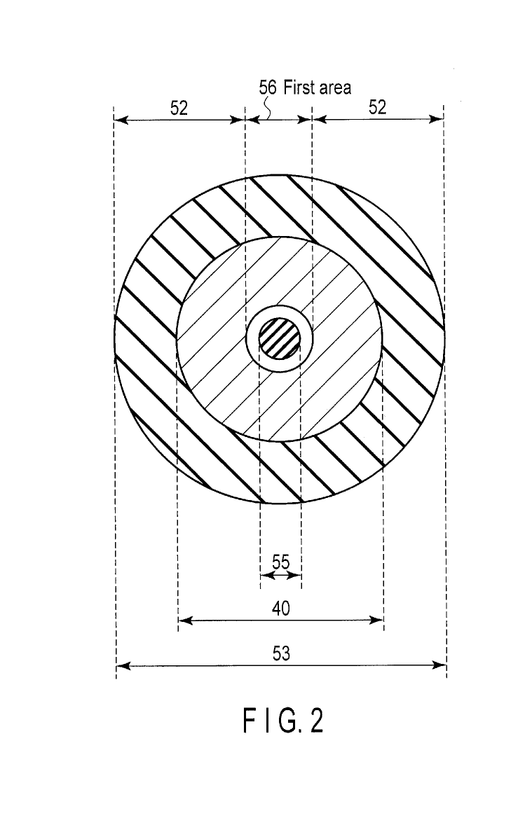

FIG. 1 is a schematic cross-sectional view showing the structure of a sensor device according to a first embodiment. FIG. 2 is a schematic plan view (plane pattern view) showing the structure of the sensor device according to the first embodiment. The sensor device of the embodiment is applied to a variable capacitor (pressure sensor).

As shown in FIG. 1, a variable capacitor 100 is formed on an underlying layer 10. The underlying layer 10 is formed mainly of an interlayer insulating layer. The interlayer insulating layer is formed on a semiconductor substrate provided with a transistor, and interconnects are formed in the interlayer insulating layer. The variable capacitor 100 comprises a lower electrode (first electrode) 20 fixed to the underlying layer 10, and a movable upper electrode (second electrode) 40 provided above the lower electrode 20. The lower and upper electrodes 20 and 40 are formed of a metal material. An insulating layer 30 is formed on the underlying layer 10 and the lower electrode 20.

The variable capacitor 100 is covered with a stacked structure 50 formed of a plurality of layers. The plurality of layers include a lowermost layer 51 and an uppermost layer 53, and an intermediate layer (predetermined layer) 52 is provided therebetween. A cavity 60 is formed as a sealed space in the stacked structure 50 that covers the variable capacitor 100. The stacked structure 50 functions as a pressure sensing portion.

The stacked structure 50 includes an anchor portion (connection) 55 connected to the upper electrode 40. Further, the lowermost layer 51 included in the layers covering the variable capacitor 100 is depressed at the anchor portion 55. The intermediate layer 52 is removed in a first area 56 that includes at least part of the anchor portion 55. In other words, no intermediate layer 52 is provided in the first area 56, and the first area 56 is defined by the lowermost layer 51 and the uppermost layer 53. In the first embodiment, the first area 56 includes the entire area including the anchor portion 55. Accordingly, no intermediate layer 52 is formed in the entire first area 56. In addition, the intermediate layer 52 may be further removed in an area other than the first area 56.

If pressure is externally applied to the stacked structure 50, the stacked structure 50 is displaced in accordance with the applied pressure. When the stacked structure 50 is displaced, the upper electrode 40 is also displaced via the anchor portion 55. In accordance with the displacement of the upper electrode 40, the distance between the upper and lower electrodes 40 and 20 varies, thereby varying the capacitance of the variable capacitor 100. Therefore, the pressure applied to the stacked structure 50 can be detected by measuring the capacitance of the variable capacitor 100.

The variable capacitor 100 is electrically connected to a peripheral circuit through interconnects (not shown) that are provided between the lowermost and uppermost layers 51 and 53 and in an interlayer insulating layer (not shown) covering the uppermost layer 53. For example, the variable capacitor 100 is electrically connected to the peripheral circuit by connecting the lower and upper electrodes 20 and 40 to interconnects that are provided between the intermediate and uppermost layers 52 and 53, between in the lowermost and intermediate layers 51 and 52, and in the interlayer insulating layer covering the uppermost layer 53.

The lowermost layer 51 is the lowest one of the layers included in the sensor device. The lowermost layer 51 may be a single layer or may consist of a plurality of layers. Regardless of the number of the layers included, the lowermost layer 51 has a plurality of holes formed therethrough.

The lowermost layer 51 is an insulating layer, and is formed of, for example, an inorganic substance, such as a silicon oxide or a silicon nitride. The intermediate layer 52 is an insulating layer, and is formed of, for example, an organic substance, such as polyimide. It is desirable that the intermediate layer 52 should be a coated layer.

The uppermost layer 53 is the uppermost one of the layers included in the sensor device. The uppermost layer 53 may be a single layer or may be formed of a plurality of layers. The uppermost layer 53 has a lower gas (such as a moisture) permeability than the intermediate layer 52. For example, a layer (outermost layer) of the uppermost layer 53 located at a furthest distance from the variable capacitor has a lower gas (such as a moisture) permeability than the intermediate layer 52.

The uppermost layer 53 is an insulating layer, and is formed of, for example, an inorganic substance, such as a silicon nitride.

The coefficient of thermal expansion of the intermediate layer 52 is highest among the layers covering the variable capacitor. For instance, the coefficient of thermal expansion of polyimide is about ten times higher than the silicon oxide and silicon nitride. More specifically, the coefficient of thermal expansion of the silicon oxide is 0.7 ppm/° C., while the coefficient of thermal expansion of polyimide is 10 to 40 ppm/° C.

As described above, the coefficient of thermal expansion of the intermediate layer 52 is high. Accordingly, given that the intermediate layer 52 is also provided in the first area 56, it is thermally expanded during heating, whereby the upper electrode 40 moves upward. Further, since the lowermost layer 51 of the stacked structure 50 is depressed in the anchor portion 55, the intermediate layer 52 is formed in the depressed portion, and the intermediate layer's volume is increased in the anchor portion 55. Especially when the intermediate layer 52 is a coated layer, the volume of the intermediate layer 52 in the anchor portion 55 is extremely increased. This causes the intermediate layer 52 to be much more thermally expanded in the anchor portion 55, thereby further increasing the upward movement of the upper electrode 40. As a result, the distance between the upper and lower electrodes of the variable capacitor 100 is increased, and hence a change in capacitance is reduced to thereby make it difficult to accurately detect a change in pressure.

In the first embodiment, no intermediate layer 52 is provided in the first area 56 that includes the anchor portion 55. In other words, the intermediate layer 52 is discontinuous in the first area 56, and the first area 56 is formed of only two layers, i.e., the lowermost layer 51 and the uppermost layer 53. By thus providing no intermediate layer 52 in the first area 56, the upper electrode is prevented from upwardly moving because of thermal expansion of the intermediate layer 52 during heating (for, for example, forming the uppermost layer 53). As a result, the pressure in the outer space of the stacked structure 50 can be accurately detected.

Referring now to FIGS. 1, 2 and 3 to 5, a description will be given of a method of manufacturing the sensor device according to the first embodiment.

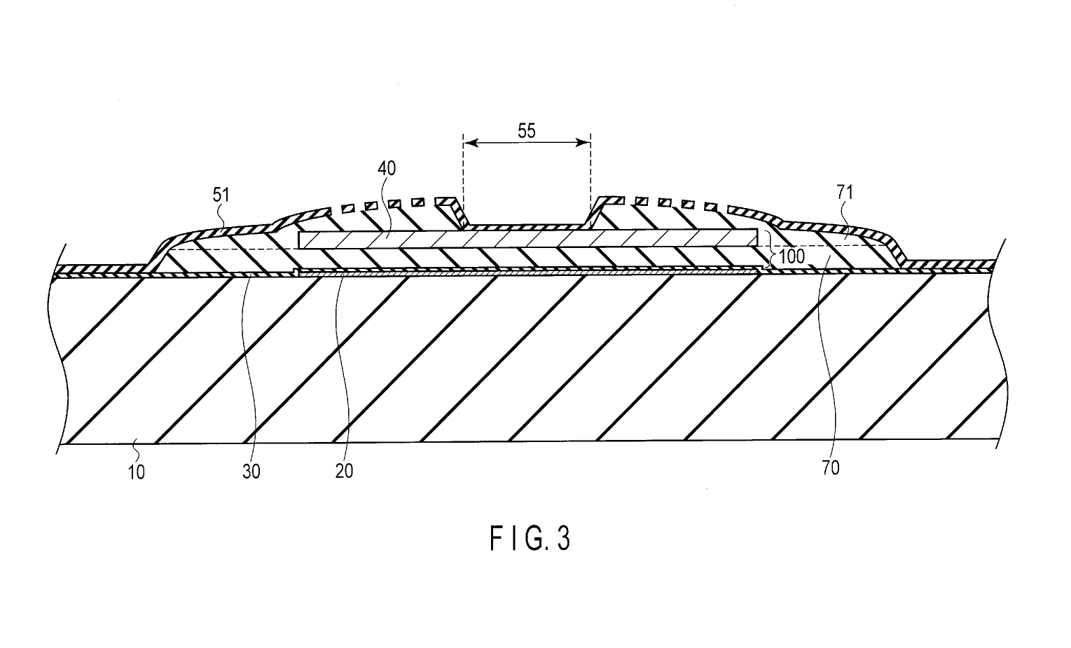

Firstly, as shown in FIG. 3, the lower electrode layer of the variable capacitor 100 is formed on the underlying layer 10. A metal material is used for the lower electrode layer, for example. Subsequently, the lower electrode layer is patterned into the lower electrode 20.

Subsequently, an insulating layer 30 is formed on the underlying layer 10 and the lower electrode 20.

Subsequently, a sacrificial layer 70 is formed using an organic insulating layer of, for example, polyimide. On sacrificial layer 70, a photoresist pattern (not shown) is formed.

Subsequently, sacrificial layer 70 is patterned using the photoresist pattern as a mask. The photoresist pattern is then removed.

Subsequently, the upper electrode layer of the variable capacitor 100 is formed, using, for example, a metal material, and is then patterned into the upper electrode 40.

Subsequently, a sacrificial layer 71 is formed using an organic insulating layer of, for example, polyimide. Sacrificial layer 71 is then patterned.

Subsequently, the lowermost layer 51 of the stacked structure 50 is formed, using insulating layers, such as a silicon oxide and silicon nitride. A plurality of holes are formed in the lowermost layer 51 above the upper electrode 40.

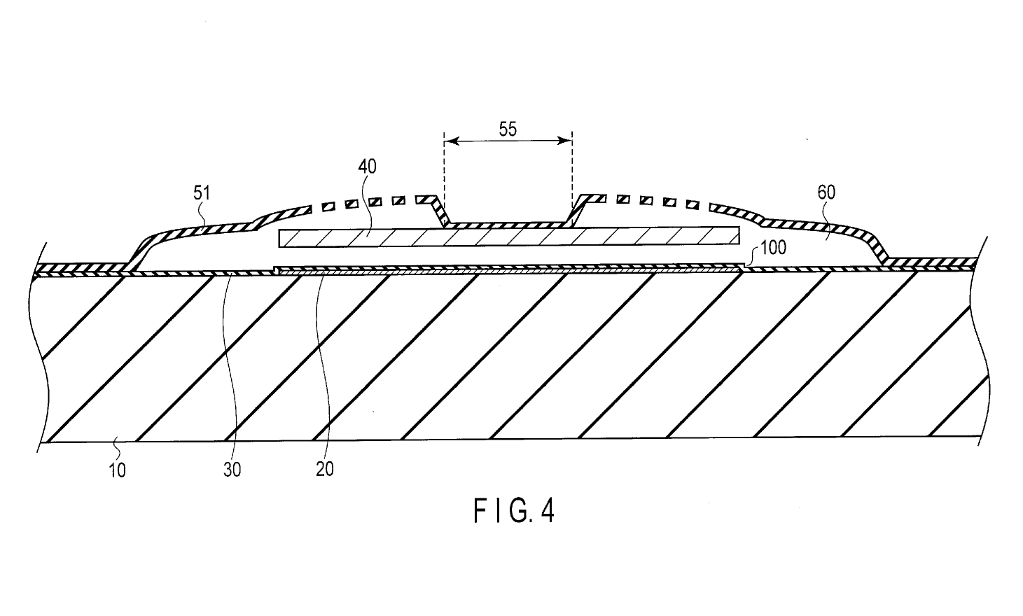

Subsequently, asking is performed through the holes formed in the lowermost layer 51, thereby removing sacrificial layers 70 and 71. Thus, as shown in FIG. 4, a cavity 60 is formed inside the lowermost layer 51.

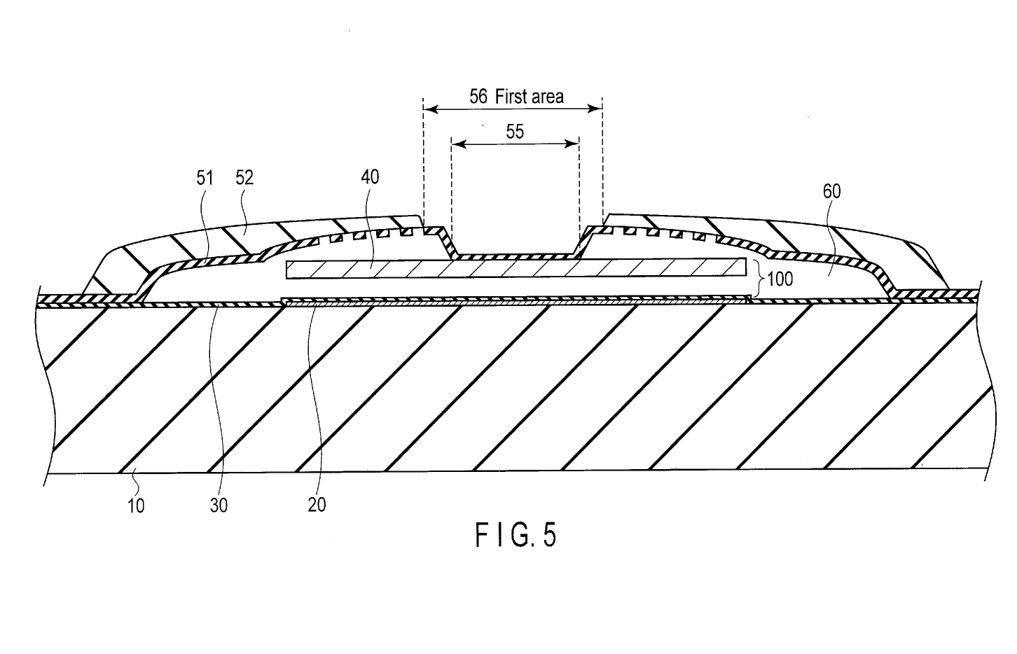

Subsequently, as shown in FIG. 5, using an organic insulating layer of, for example, polyimide, the intermediate layer 52 of the stacked structure 50 is formed on the resultant structure where the lowermost layer 51, for example, is formed. The intermediate layer 52 seals the holes in the lowermost layer 51. It is desirable that the intermediate layer 52 should be a coated layer. After that, the intermediate layer 52 is patterned. During this patterning, the intermediate layer 52 is removed from the first area 56.

Subsequently, on the structure where the intermediate layer 52, for example, is formed, the uppermost layer 53 of the stacked structure 50 is formed using an insulating layer of, for example, a silicon nitride. The uppermost layer 53 is formed at a high temperature of approx. 100 to 500° C., using a film forming method, such as chemical vapor deposition (CVD). Alternatively, part of or the entire portion of the uppermost layer 53 may be formed using, for example, sputtering.

The structure shown in FIGS. 1 and 2 is formed as described above.

Since in the first embodiment, the intermediate layer 52 is removed from the first area 56 of the stacked structure 50, upward movement of the upper electrode 40 connected to the anchor portion 55, due to the heat generated when the uppermost layer 53 is formed, is suppressed.

### Second Embodiment

A second embodiment will now be described. A sensor device according to the second embodiment is applied to a variable capacitor, like the first embodiment. The second embodiment is similar to the first embodiment in basic structure and manufacturing method. Therefore, matters similar to those described in the first embodiment will not be described.

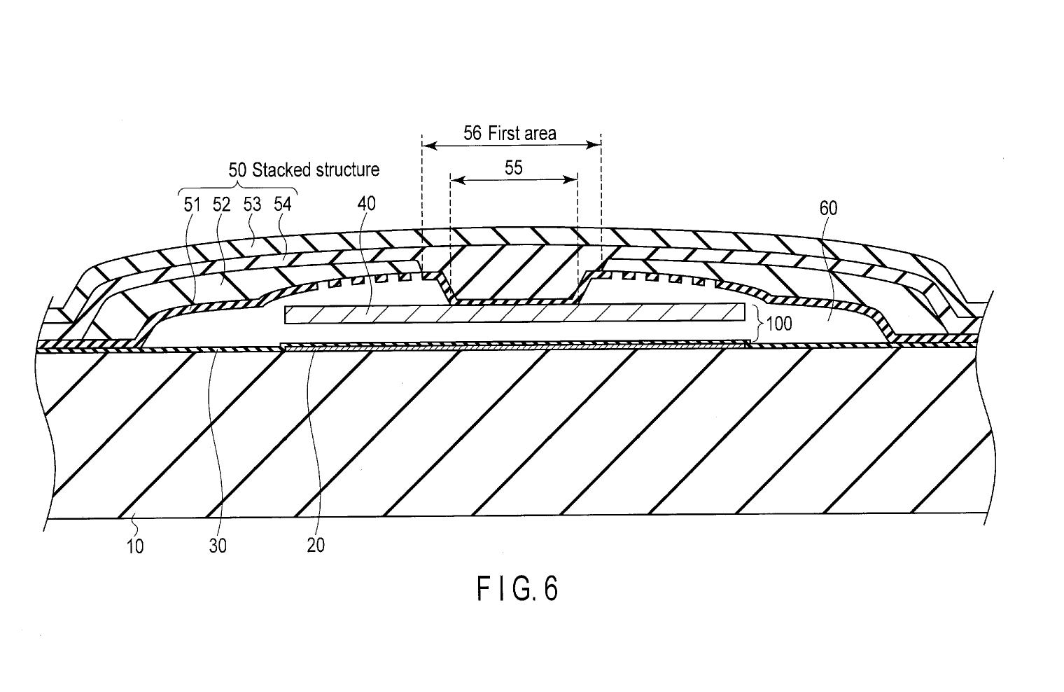

FIG. 6 is a schematic cross-sectional view showing the structure of the sensor device according to the second embodiment. In the second embodiment, elements similar to those of the first embodiment are denoted by corresponding reference numbers, and no detailed description will be given thereof.

Also in the second embodiment, no intermediate layer 52 is provided in the first area 56. In the second embodiment, an auxiliary layer 54 is provided to bury the depression in the anchor portion 55. The auxiliary layer 54 is located in the first area 56 between the lowermost layer 51 and the uppermost layer 53, and is located between the intermediate layer (predetermined layer) 52 and the uppermost layer 53 in the area other than the first area 56. That is, the stacked structure 50 comprises four layers, i.e., the lowermost layer 51, the intermediate layer 52, the auxiliary layer 54 and the uppermost layer 53, while the first area 56 comprises three layers, i.e., the lowermost layer 51, the auxiliary layer 54 and the uppermost layer 53.

A material having a low coefficient of thermal expansion, such as a silicon oxide, a silicon nitride, etc., is used for the auxiliary layer 54. The use of a material having a low coefficient of thermal expansion for the auxiliary layer 54 prevents the upper electrode 40 from upwardly moving because of thermal expansion of the stacked structure 50. For instance, SiON, SiOC, SiO or SiN is used for the auxiliary layer 54.

The auxiliary layer 54 is formed by, for example, coating the structure having the intermediate layer 52 with a coating material. By providing the auxiliary layer 54 by coating, the depression in the anchor portion 55 can be efficiently buried to thereby flatten the upper surface of the auxiliary layer 54. Therefore, the uppermost layer 53 can be formed on the flat upper surface of the auxiliary layer 54.

As described above, also in the second embodiment, no intermediate layer 52 is formed in the first area 56, and therefore, the same effect as the first embodiment can be achieved. In addition, in the second embodiment, the provision of the auxiliary layer 54 increases the strength of the stacked structure 50, especially, the strength of the anchor portion 55.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sensor device comprising:
a variable capacitor including a first electrode fixed to an underlying layer, and a movable second electrode provided above the first electrode; and
a stacked structure including a plurality of layers and having a connection connected to the second electrode, the stacked structure covering the variable capacitor and forming a cavity therein,
wherein a predetermined layer included in the plurality of layers is not provided in a first area that includes at least part of the connection.

2. The sensor device of claim 1, wherein the predetermined layer is formed of a material having a high coefficient of thermal expansion.

3. The sensor device of claim 1, wherein the predetermined layer is formed of an organic material.

4. The sensor device of claim 3, wherein the organic material includes polyimide.

5. The sensor device of claim 1, wherein the predetermined layer is a coated layer.

6. The sensor device of claim 1, wherein a lowermost layer included in the plurality of layers has a depression at the connection.

7. The sensor device of claim 1, wherein a lowermost layer included in the plurality of layers has a hole.

8. The sensor device of claim 7, wherein the predetermined layer fills the hole.

9. The sensor device of claim 7, wherein the hole is positioned above the second electrode.

10. The sensor device of claim 1, wherein a lowermost layer included in the plurality of layers is formed of an inorganic substance.

11. The sensor device of claim 1, wherein an uppermost layer included in the plurality of layers is formed of an inorganic substance.

12. The sensor device of claim 1, wherein the plurality of layers include
a lowermost layer and an uppermost layer, and the predetermined layer is located between the lowermost and uppermost layers.

13. The sensor device of claim 12, wherein the plurality of layers further include an auxiliary layer located between the lowermost and uppermost layers in the first area, and located between the predetermined and uppermost layers in an area other than the first area.

14. The sensor device of claim 13, wherein the lowermost layer has a depression at the connection, and the auxiliary layer fills the depression.

15. The sensor device of claim 13, wherein the auxiliary layer is a coated layer.

16. The sensor device of claim 1, wherein the first area includes an entire area in which the connection is provided.

17. The sensor device of claim 1, wherein the sensor device functions as a pressure sensor.

18. The sensor device of claim 17, wherein the stacked structure functions as a pressure sensing portion.
